(19) United States
(12) Patent Application Publication
(10) Pub. No.: US 2014/0278917 A1
(43) Pub. Date: Sep. 18, 2014

(54) Systems and Methods for Creating Product Advertising Campaigns

(71) Applicant: DataPop, Inc., Los Angeles, CA (US)

(72) Inventors: Stephen John Zimmerman, Jr., Los Angeles, CA (US); Robert Manly, Los Angeles, CA (US); Maggie Yeh Chen, San Mateo, CA (US); Kelvin Li, Kowloon (HK); David Schwartz, South Pasadena, CA (US)

(21) Appl. No.: 13/919,792

(22) Filed: Jun. 17, 2013

Related U.S. Application Data
(63) Continuation of application No. 13/799,509, filed on Mar. 13, 2013.

(51) Int. Cl. G06Q 30/02

(52) U.S. Cl. CPC G06Q 30/0256; G06Q 30/0276
USPC 705/14.43; 705/14.54; 705/14.41

(57) ABSTRACT

Systems and methods for creating product advertising campaigns in accordance with embodiments of the invention are disclosed. In one embodiment, a product target generation server system includes a processor, product data including a plurality of attribute-value pairs describing a set of products, semantic models including data describing relationships between product targets, concepts described using categories and attribute-value pairs, and target grouping data constituting a set of groupings of product targets, global performance data including performance data, wherein the processor is configured to identify at least one category in a portion of the product data, determine a product advertising structure based on the product data and the identified at least one category, match a portion of the groupings of product data with the product targets within the global performance data, identify performance data, and generate at least one product target using the identified performance data and the product data.

### CROSS-REFERENCE TO RELATED APPLICATIONS

The current application is a continuation application of U.S. patent application Ser. No. 13/799,509, the disclosure of which is hereby incorporated by reference in its entirety.

### FIELD OF THE INVENTION

The present invention relates to targeted search advertising and more specifically to the creation of product advertising campaigns.

### BACKGROUND

The term e-commerce is used to refer to the buying and selling of products or services over electronic systems such as the Internet and other computer networks. The amount of trade conducted via e-commerce has grown extraordinarily with widespread Internet usage. As a result, a variety of websites have been established to offer goods and services.

Search engines are useful tools for locating specific pages of information on the World Wide Web and are increasingly used to locate goods and services. As a result, many websites use search advertising/search engine marketing to attract visitors to product, service, and/or category landing pages. Search advertising describes the placement of online advertisements adjacent or amongst the search results returned by a search engine in response to a specific search query. Search engine marketing typically involves paying for a specific online advertisement or creative to be featured in or adjacent to the search results provided in response to a specific query. Typically, the position of an advertisement within the returned search results is a function of the bid scaled by a quality factor that measures the relevance of the creative and landing page combination to the search query. Accordingly, the provider of the search engine is incentivized to feature relevant keyword/advertisement/landing page combinations so that users will select featured advertisements and increase the revenue generated by the search engine provider. In the context of paid search advertising, the term keyword refers to both a single word and a specific combination of words or keyword components.

When a website includes a large number of products or services, the process of building and managing a paid search advertising campaign can be quite complex. Many search engines provide the ability to upload an entire advertising campaign including one or more creatives that target a set of keywords, and associated bids to be used when the display of the creative is triggered by specific keywords. For example, Google, Inc. of Mountain View, Calif., defines an Ad Group file format that enables advertisers to upload paid search advertising campaigns.

### SUMMARY OF THE INVENTION

Systems and methods for creating product advertising campaigns in accordance with embodiments of the invention are disclosed. In one embodiment, a product target generation server system includes a processor, a memory connected to the processor and configured to store a product advertisement generation application, product data storage configured to store product data, where the product data includes a plurality of attribute-value pairs describing a set of products, semantic model storage configured to store semantic models including data describing relationships between product targets, concepts described using categories and attribute-value pairs, and target grouping data constituting a set of groupings of product targets, and performance data storage configured to store global performance data including performance data for product targets and target grouping data across a plurality of existing product advertising strategies, where the target grouping data describes groupings of product targets and product data wherein the product advertisement generation application configures the processor to identify at least one category in a portion of the product data based upon the attribute-value pairs in the product data that associated with the category, determine a product advertising structure based on the product data and the identified at least one category, where the product advertising structure includes one or more groupings of product data, match a portion of the groupings of product data with the product targets within the global performance data based on the attribute-value pairs of the product data associated within the portion of the groupings of product data, identify performance data within the global performance data based on the matched product targets, and generate at least one product target using the identified performance data and the product data, where a product target includes a set of product attribute-value pairs identifying a portion of the product data.

In an additional embodiment of the invention, the product advertisement generation application further configures the processor to create a product advertisement campaign including the at least one product target and portion of the product data.

In another embodiment of the invention, the product advertisement generation application further configures the processor to transmit the product advertising campaign to a search engine provider.

In yet another additional embodiment of the invention, the product advertisement generation application further configures the processor to obtain campaign performance data describing the performance of the product adverting campaign.

In still another additional embodiment of the invention, the product advertisement generation application further configures the processor to determine the performance of a portion of the at least one product target in the product advertising campaign based on the campaign performance data, refine at least one of the portion of the at least one product target based on the determined performance, and update the product advertising campaign to include the refined product target.

In yet still another additional embodiment of the invention, the product advertisement generation application further configures the processor to generate at least one product bucket within the product advertising structure including at least one product target and product data associated with the at least one product target, where a product bucket is a conceptual grouping of the at least one product target and product data based on one or more attributes, determine performance information for the at least one product bucket based on the performance data, identify the top product bucket within the at least one product bucket with the best performance in the at least one product bucket, refine at least one of the at least one product target in the other at least one product bucket based on the top product targets contained in the top product bucket, and update the product advertising campaign based on the refined product targets.

In yet another embodiment of the invention, the product advertisement generation application configures the processor to generate at least one product group including at least one product target and product data associated with the at least one product target within the product advertising structure.

In still another embodiment of the invention, the product advertisement generation application further configures the processor to obtain search performance data from a search engine provider, where the search performance data describes the performance of at least one attribute-value pair associated with a piece of product data and generate at least one performance product group within the product advertising structure based on the search performance data, where a performance product group includes product data and associated product targets, where each piece of product data in the performance product group is associated with the same portion of the obtained search performance data.

In yet still another embodiment of the invention, the product advertising structure further includes a bidding strategy and the product advertisement generation application further configures the processor to determine a bidding strategy based on the product targets and the product data, where the bidding strategy includes one or more bid prices associated with a product target, determine a bid price for the product advertising campaign based on the product advertising structure, and include the bid prices in the product advertising campaign.

In yet another additional embodiment of the invention, the product advertisement generation application further configures the processor to generate at least one product target based on a piece of product data and the semantic model.

In still another additional embodiment of the invention, the generated product target is grammatically correct based on the attribute-value pairs of the product data associated with the product target.

In yet still another additional embodiment of the invention, the semantic model is a scheme for classifying product data based on the attribute-value pairs of the product data and relationships between the attributes of the product data.

In yet another embodiment of the invention, the product advertising campaign is designed to associate at least one piece of product data to one or more keywords in a search query based on the at least one product target.

In still another embodiment of the invention, the product advertisement generation application further configures the processor to generate a product feed based on the identified performance data.

Yet another embodiment of the invention includes a method for creating product advertising targets including identifying at least one category in a portion of product data based upon the attribute-value pairs in the product data that associated with the category using a product advertisement generation server system, determining a product advertising structure based on the product data and the identified at least one category using the product advertisement generation server system, where the product advertising structure includes one or more groupings of product data, matching a portion of the groupings of product data with the product targets within the global performance data based on the attribute-value pairs of the product data associated within the portion of the groupings of product data using the product advertisement generation server system, identifying performance data within the global performance data based on the matched product targets using the product advertisement generation server system, and generating at least one product target based on the identified performance data and the product data using the product advertisement generation server system, where a product target includes a set of product attribute-value pairs identifying a portion of the product data.

In yet another additional embodiment of the invention, generating product advertising targets further includes creating a product advertisement campaign including the at least one product target and portion of the product data using the product advertisement generation server system.

In still another additional embodiment of the invention, generating product advertising targets further includes transmitting the product advertising campaign to a search engine provider using the product advertisement generation server system.

In yet still another additional embodiment of the invention, generating product advertising targets further includes obtaining campaign performance data describing the performance of the product adverting campaign using the product advertisement generation server system.

In yet still another additional embodiment of the invention, generating product advertising targets further includes determining the performance of a portion of the at least one product target in the product advertising campaign based on the campaign performance data using the product advertisement generation server system, refining at least one of the portion of the at least one product target based on the determined performance using the product advertisement generation server system, and updating the product advertising campaign to include the refined product target using the product advertisement generation server system.

In yet another embodiment of the invention, generating product advertising targets further includes generating at least one product bucket within the product advertising structure including at least one product target and product data associated with the at least one product target using the product advertisement generation server system, where a product bucket is a conceptual grouping of the at least one product target and product data based on one or more attributes, determining performance information for the at least one product bucket based on the performance data using the product advertisement generation server system, identifying the top product bucket within the at least one product bucket with the best performance in the at least one product bucket using the product advertisement generation server system, refining at least one of the at least one product target in the other at least one product bucket based on the top product targets contained in the top product bucket using the product advertisement generation server system, and updating the product advertising campaign based on the refined product targets using the product advertisement generation server system.

In still another embodiment of the invention, generating product advertising targets further includes generating at least one product group including at least one product target and product data associated with the at least one product target within the product advertising structure using the product advertisement generation server system.

In yet still another embodiment of the invention, generating product advertising targets further includes obtaining search performance data from a search engine provider using the product advertisement generation server system, where the search performance data describes the performance of at least one attribute-value pair associated with a piece of product data and generating at least one performance product group within the product advertising structure based on the search performance data using the product advertisement generation server system, where a performance product group includes product data and associated product targets, where each piece of product data in the performance product group is associated with the same portion of the obtained search performance data.

In yet another additional embodiment of the invention, generating product advertising targets further includes determining a bidding strategy based on the product targets and the product data using the product advertisement generation server system, where the bidding strategy includes one or more bid prices associated with a product target, determining a bid price for the product advertising campaign based on the product advertising structure using the product advertisement generation server system, and including the bid prices in the product advertising campaign using the product advertisement generation server system.

### BRIEF DESCRIPTION OF THE DRAWINGS

FIG. 1 is a conceptual illustration of a product advertising system in accordance with an embodiment of the invention.

FIG. 2 is a conceptual illustration of a product advertising server system in accordance with an embodiment of the invention.

FIG. 3 is a flow chart illustrating a process for creating a product advertising campaign in accordance with an embodiment of the invention.

FIG. 4 is a flow chart illustrating a process for updating a product advertising campaign in accordance with an embodiment of the invention.

### DETAILED DESCRIPTION

Turning now to the drawings, systems and methods for creating product advertising campaigns in accordance with embodiments of the invention are disclosed. Product listing advertising involves the presentation of product advertising campaigns designed to advertise one or more products identified as relevant to keywords in a search query alongside the search results presented by a search engine provider for the search query. Product advertising campaigns in accordance with embodiments of the invention include a plurality of product advertisements that contain sets of information or structured data describing one or more products and/or services that are the subject(s) of the product advertising campaign along with product targets that group the product advertisements. Product advertising server systems in accordance with embodiments of the invention are configured to generate product advertisements containing sets of information or structured data that are targeted toward keywords and/or phrases (and/or the intent described by the keywords and/or phrases) contained in search queries provided to a search engine provider. The information and/or structured data in the product advertisements can be utilized by a search engine provider to generate an ad copy based on the product data in the product feed. An ad copy is text describing the product in the product advertisement as displayed alongside the search results. In many embodiments, generating a product advertising campaign utilizes a semantic model. The term semantic model is used to describe a particular scheme for classifying products and/or services. Collectively products and/or services (indeed any object, person, idea, or action) can be referred to as a concept and, in many embodiments, concepts can be defined in terms of categories and attribute value pairs. In this way, a semantic model used to build product advertising campaigns can also include elements of a taxonomy and/or an ontology in the sense that the possible attributes of classified concepts and groupings of concepts can also be specified, as can the relationships (including hierarchical relationships) between those attributes. In several embodiments, a semantic model is constructed based upon keywords used by people searching for the specific products and/or services that are featured in the product advertising campaign. The semantic model can also be used to identify relationships between keyword components and the categories and attributes within the semantic model and these relationships used to identify potentially relevant attributes for use in creating product targets within a product advertising campaign, such as name patterns (e.g. how a product name is displayed) and phrase patterns (e.g. how the details of a product are displayed). Effective or optimal product targets can then be automatically generated based upon the attributes of products and product targets that are likely to perform well with respect to specific queries targeted by the product advertising campaign.

A product target and associated product data are combined to form the specific product advertisement that is displayed as part of the search engine results. The product advertisement is designed to direct users to a landing page affiliated with the product target and/or the product data. Different products can be displayed with respect to the same landing page in response to different search queries. Product advertising server systems are configured to generate product advertising campaigns including a plurality of product targets based on a product data feed containing one or more products, where a product is defined as a set of attribute-value pairs. Products can be grouped into one or more groups of products based on the attributes and values associated with each of the products. Bidding strategies for the product advertising campaign are determined based on the product groupings and/or the product data. Product targets are generated based on the product data, a semantic model, and/or performance data related to the attributes and values in the product data. Product advertising campaigns are generated based on the product data and the product targets; the product advertising campaigns can also include product groups containing one or more product targets and the associated product data. Product advertising campaigns can also include bidding data related to the cost associated with transmitting the product advertising campaign to a search engine provider and/or having the search engine provider present the product advertisements in the product advertising campaign.

In a variety of embodiments, product advertising server systems are configured to receive performance data related to the product advertising campaigns and/or other product advertising campaigns and update the product targets, the product groupings, and/or the product data based on the performance data. Performance data for one or more product advertising campaigns includes a variety of data, including product targets, product groupings, product advertising strategies, and the associated performance data; additional performance data not listed can be utilized as appropriate to the requirements of a specific application in accordance with embodiments of the invention. Product advertising server systems can also be configured to create one or more product “buckets” within the product advertising campaign and, by comparing the relative performance of the product buckets, update the product groupings, product targets, and/or product data based on the performance of the product buckets.

Although much of the discussion that follows relates to product advertising campaigns, the same systems and methods in accordance with embodiments of the invention that are used to generate targets in product listing advertising campaigns can also be utilized to generate product data streams. Product data streams contain attribute-value pairs describing products and/or services. In many embodiments, the product data stream describes the products that are being advertised within the product listing advertising campaign. Systems and methods for creating and updating product advertising campaigns in accordance with embodiments of the invention are discussed below.

### Product Advertising Systems

Product advertising systems are configured to deliver product advertisements to user devices alongside search results provided in response to received search queries. Product advertising server systems in accordance with many embodiments of the invention are configured to create product advertising campaigns using product targets targeted toward the search terms used to search for the products and/or services that are related to the products advertised in the product advertising campaign and deploy product advertising campaigns to search engine providers. A diagram of a product advertising system in accordance with an embodiment of the invention is shown in FIG. 1. The product advertising system 100 includes a product advertising server system 110, a search engine provider 112, and user devices including computers 130, tablets 132, and mobile phones 134 configured to communicate via a network 120. In a variety of embodiments, the network 120 is the Internet. In a number of embodiments, the advertising server system 110 is implemented using a single server system. In several embodiments, the advertising server system 110 is implemented using multiple server systems.

The search engine provider 112 is configured to present product advertisements to the user devices based on keywords and/or phrases contained in search queries provided by the user devices to the search engine provider 112. The product advertising server system 110 is configured to create product advertising campaigns based on a product feed including one or more pieces of product data and semantic models describing schemes for categorizing the product data. In several embodiments, the product advertising server system 110 is further configured to create a product advertising campaign based on performance data associated with the product data and/or the product targets. In many embodiments, the product advertising campaigns are organized into product groups, where a product group has one or more product targets and product data associated with the product targets. In a variety of embodiments, the product advertising server system 110 is configured to receive performance data and/or keyword data from the search engine provider 112 and utilize the received performance data and/or keyword data in the creation and/or update of product advertising campaigns. The product advertising server system 110 is further configured to provide the created product advertising campaign to the search engine provider 112. In many embodiments, the product advertising server system 110 is configured to determine a bidding strategy for the product advertising campaign and execute the bidding strategy when transmitting the product advertising campaign to the search engine provider 112.

Although a specific architecture of a product advertising system in accordance with embodiments of the invention are discussed above and illustrated in FIG. 1, a variety of architectures, including user devices not specifically named and other methods of serving product advertising campaign information to user devices, can be utilized in accordance with embodiments of the invention. Systems and methods for creating product advertising campaigns are discussed below.

### Product Advertising Server Systems

Product advertising server systems in accordance with embodiments of the invention are configured to generate product targets used to advertise product data in a product advertising campaign. A conceptual illustration of a product advertising server system in accordance with an embodiment of the invention is shown in FIG. 2. The product advertising server system 200 includes a processor 210 in communication with memory 230. The product advertising server system 200 also includes a network interface 220 configured to send and receive data over a network connection. In a number of embodiments, the network interface 220 is in communication with the processor 210 and/or the memory 230. In several embodiments, the memory 230 is any form of storage configured to store a variety of data, including, but not limited to, a product advertisement generation application 232, a product data feed 234, semantic model 236, and/or performance data 238. In many embodiments, the advertising product data generation application 232, performance data 234, semantic model 236, and/or global performance data 238 are stored using an external server system and received by the advertising creative generation device 200 using the network interface 220.

The processor 210 is configured by the advertising product data generation application 232 to generate product advertising campaigns including one or more product advertisements and/or product grouping data. A product advertisement includes data describing a product target and product data associated with the product target. The product data feed 234 includes one or more pieces of product data. The product data is used along with the semantic model 236 and/or the performance data 238 to generate the product targets. The attributes and values associated with the product data can be used along with the semantic model 236 and/or the performance data 238 to generate product group data, where the product group data organizes product advertisements into groups based on one or more grouping criteria. Grouping criteria that can be utilized in accordance with embodiments of the invention are described below. In a variety of embodiments, the advertising product data generation application 232 configures the processor 210 obtain additional performance data 238 related to the performance of the product advertising campaign and to update product advertising campaigns based on the updated performance data 238. In many embodiments, the performance of product advertisements within one or more product buckets that are designed to be compared and the product advertising campaign is updated based on the best performing product bucket(s). Bidding data is generated based on the product advertising campaign and used in the transmission of the product advertising campaign to a search engine provider.

Although a specific architecture for a product advertising server system in accordance with an embodiment of the invention is conceptually illustrated in FIG. 2, any of a variety of architectures, including those which store data or applications on disk or some other form of storage and are loaded into memory at runtime and systems that are distributed across multiple physical servers, can also be utilized in accordance with embodiments of the invention. Methods for creating product advertising campaigns in accordance with embodiments of the invention are discussed below.

### Creating Product Advertising Campaigns

Product advertising campaigns are designed to target product advertisements to keywords present in search queries processed by a search engine provider. The search engine provider is configured to present relevant product advertisements alongside the search results corresponding to a search query. Product advertising server systems in accordance with embodiments of the invention are configured to create product advertising campaigns based on a product feed. A process for creating product advertising campaigns in accordance with an embodiment of the invention is illustrated in FIG. 3. The process 300 includes obtaining (310) a product feed. A product advertising structure is created (312). A bidding strategy is determined (314). Product targets are generated (316) and, in many embodiments, the bidding strategy is optimized (318). A product advertising campaign is created (320). In a variety of embodiments, the product advertising campaign is transmitted (322).

In several embodiments, the product feed is obtained (310) from a merchant, although a product feed can be obtained (310) from any source as appropriate to the requirements of a specific application in accordance with embodiments of the invention. The obtained (310) product feed includes a plurality of pieces of product data; product data includes a set of attribute-value pairs describing the properties of the product represented by the product data. Creating (312) a product advertising structure for the created (320) product advertising campaign includes determining one or more product groups along with a bidding strategy based upon the product groupings for the product data in the obtained (310) product feed. In a variety of embodiments, the product groups include one or more product targets. In a number of embodiments, product data is grouped based on the attributes and/or the values within the product data. A variety of attributes and/or criteria can be utilized to group products, including product categories, brands, colors, sizes, shapes, condition (such as new, used, and refurbished), price, associated promotions (such as free shipping and coupons), and stock-keeping units. Inferred attributes can also be utilized to group products; inferred attributes include, but are not limited to, luxury products, value products, seasonal products, and/or other inferred attributes appropriate to specific applications. Inferred attributes include associating attributes and/or values that are different but share common characteristics. For example, for the attribute ‘color,’ the values ‘blue,’ ‘azure,’ ‘navy,’ and ‘sky blue’ can all be grouped together as they are all shades of blue. In many embodiments, products are grouped based on performance metrics, such as profit margin, conversion rates, click-through rates, return on advertising spending, and return on investment. In several embodiments, the products are grouped based on the determined (314) bidding strategy. In a number of embodiments, the products are grouped based on search performance data retrieved from a search engine provider, where the search performance data identifies commonly used keywords associated with the attribute-value pairs associated with the product data being grouped. In a number of embodiments, the products are grouped into product buckets, where each product bucket is associated with one or more grouping criteria (such as those described above) and the product buckets are designed so that the performance of the product targets and/or product data associated with the product buckets can be compared against each other to determine the relative performance of the product buckets. Other criteria can be utilized to group products, as appropriate to the requirements of a specific application in accordance with embodiments of the invention.

In a variety of embodiments, the determined (314) bidding strategy is based on the product advertising structure and/or the attribute-value pairs associated with the product data. Different bidding strategies can be determined for one or more of the product groups within the product advertising structure based on the properties of the particular product groups and/or the products contained in the product groups. In many embodiments, product targets are generated (316) for the product data using a semantic model. The semantic model is utilized to generate names and phrases included in the generated (316) product targets based upon attribute-value information in the product data corresponding to name and phrase structure information in the semantic model. In a number of embodiments, the generated names and/or phrases are grammatically correct according to a target language associated with the product target. In several embodiments, the grammar of the generated names and/or phrases is based on performance data identifying effective names and/or phrases utilized in existing product advertising campaigns. In a number of embodiments, the product targets are generated (316) based on performance data, where the performance data includes information regarding similar product targets and/or product data in existing product advertising campaigns. Performance data includes, but is not limited to, the performance metrics described above.

In many embodiments, the bidding strategy is optimized (318) based on the generated (316) product targets. The optimized (318) bidding strategies can result in refining the product groups based on the aggregations of product data and/or product targets that are identified as related to the bidding strategies. A product advertising campaign is created (320) based on the generated (316) product targets, the product feed, and the product groups. In a variety of embodiments, product advertising campaigns include product advertisements (which include product targets and product data) and the product advertisements are grouped according to the product groups. In several embodiments, the product advertising campaign includes the bidding strategy. In a number of embodiments, the product advertising campaign is transmitted (322) to a search engine provider. In a number of embodiments, a search engine provider requires payment, such as in the form of a bidding system, to display product advertisements within a product advertising campaign. In several embodiments, the determined (314) and/or optimized (318) bidding strategy is executed to determine the amount of payment to be provided to the search engine provider to serve the product advertising campaign.

Although a specific process for creating product advertising campaigns in accordance with embodiments of the invention is described above with respect to FIG. 3, any number of processes can be utilized as appropriate to the requirements of a specific application in accordance with embodiments of the invention. Processes for updating product advertising campaigns in accordance with embodiments of the invention are described below.

### Updating Product Advertising Campaigns

Once a product advertising campaign is running on a search engine provider, the performance of the campaign can be analyzed with respect to the interactions with the product advertisements within the product advertising campaign via the search engine provider. Based on the performance of the product advertising campaign, product advertisements that could demonstrate improved performance are identified and the product advertising campaign updated to incorporate updated product advertisements designed to improve the overall performance of the product advertising campaign. A process for updating product advertising campaigns in accordance with an embodiment of the invention is illustrated in FIG. 4. The process 400 includes obtaining (410) a product advertising campaign. In several embodiments, product buckets including one or more groupings of products are determined (412). Performance data is analyzed (414). Product targets are refined (416) and the product advertising campaign is updated (418).

In a number of embodiments, a product advertising campaign is obtained (410) and/or product buckets are determined (412) utilizing processes similar to those described above. In a variety of embodiments, analyzing (414) performance data includes comparing the performance of product advertisements associated with one or more determined (412) product buckets. In several embodiments, performance data is analyzed (414) with respect to the impressions, click-through rates, and/or conversion rates of the product advertisements in the product advertising campaign. In a number of embodiments, performance data is analyzed (414) regarding the relevancy of the product advertisements as determined by a search engine provider. In many embodiments, performance data is analyzed (414) to identify names and/or phrases associated with product targets that do or do not perform well. In a number of embodiments, product targets include attribute-value pairs corresponding to one or more pieces of product data within a product feed. Product targets can also include other attribute-value pairs that do not appear within the product data in the product feed but are utilized by a search engine provider to identify one or more products in the product feed. Product targets can include other information as appropriate to the requirements of a specific application in accordance with embodiments of the invention. In several embodiments, product targets are refined (416) based on the analyzed (414) performance data. For example, if a product target is associated with a poorly performing phrase with respect to the product data associated with the product target, the product target is refined (416) to include a new phrase that exhibits improved performance when coupled with the product data versus the poorly performing phrase. Other aspects of the product advertisements can be refined (416) as appropriate to the requirements of a specific application in accordance with embodiments of the invention. The product advertising campaign is updated (418) based on the analyzed (414) performance data and the refined (416) product targets.

Specific processes for updating product advertising campaigns in accordance with embodiments of the invention are discussed above with respect to FIG. 4; however, a variety of processes can be utilized in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A product target generation server system, comprising:
a processor;
a memory connected to the processor and configured to store a product advertisement generation application;
product data storage configured to store product data, where the product data comprises a plurality of attribute-value pairs describing a set of products;
semantic model storage configured to store semantic models comprising data describing relationships between product targets, concepts described using categories and attribute-value pairs, and target grouping data constituting a set of groupings of product targets; and
performance data storage configured to store global performance data comprising performance data for product targets and target grouping data across a plurality of existing product advertising strategies, where the target grouping data describes groupings of product targets and product data;
wherein the product advertisement generation application configures the processor to:
identify at least one category in a portion of the product data based upon the attribute-value pairs in the product data that associated with the category;
determine a product advertising structure based on the product data and the identified at least one category, where the product advertising structure includes one or more groupings of product data;
match a portion of the groupings of product data with the product targets within the global performance data based on the attribute-value pairs of the product data associated within the portion of the groupings of product data;
identify performance data within the global performance data based on the matched product targets, where the identified performance data corresponds to the attribute-value pairs in the matched portion of the groupings of product data; and
generate at least one product target using the identified performance data, the semantic model, and the product data, wherein:
a product target comprises a set of product attribute-value pairs identifying a portion of the product data; and
the product target is augmented with at least one attribute-value pair described in the semantic model selected based on the identified performance data for at least one product target in the matched portion of the groupings of product data.

2. The system of claim 1, wherein the product advertisement generation application further configures the processor to create a product advertisement campaign comprising the at least one product target and portion of the product data.

3. The system of claim 2, wherein the product advertisement generation application further configures the processor to transmit the product advertising campaign to a search engine provider.

4. The system of claim 3, wherein the product advertisement generation application further configures the processor to obtain campaign performance data describing the performance of the product advertising campaign.

5. The system of claim 4, wherein the product advertisement generation application further configures the processor to:
determine the performance of a portion of the at least one product target in the product advertising campaign based on the campaign performance data;
refine at least one of the portion of the at least one product target based on the determined performance; and
update the product advertising campaign to include the refined product target.

6. The system of claim 4, wherein the product advertisement generation application further configures the processor to:
generate a set of product buckets within the product advertising structure including at least one product target and product data associated with the at least one product target, where a product bucket is a conceptual grouping of the at least one product target and product data based on one or more attributes;
determine performance information for at least one product bucket in the set of product buckets based on the performance data;
identify the top product bucket within the set of product buckets with the best performance;
refine at least one of the at least one product target in at least one other product bucket in the set of product buckets based on the top product targets contained in the top product bucket; and
update the product advertising campaign based on the refined product targets.

7. The system of claim 1, wherein the product advertisement generation application configures the processor to generate at least one product group including at least one product target and product data associated with the at least one product target within the product advertising structure.

8. The system of claim 7, wherein the product advertisement generation application further configures the processor to:
obtain search performance data from a search engine provider, where the search performance data describes the performance of at least one attribute-value pair associated with a piece of product data; and
generate at least one performance product group within the product advertising structure based on the search performance data, where a performance product group includes product data and associated product targets, where each piece of product data in the performance product group is associated with the same portion of the obtained search performance data.

9. The system of claim 1, wherein:
the product advertising structure further comprises a bidding strategy; and
the product advertisement generation application further configures the processor to:
determine a bidding strategy based on the product targets and the product data, where the bidding strategy comprises one or more bid prices associated with a product target;
determine a bid price for the product advertising campaign based on the product advertising structure; and
include the bid prices in the product advertising campaign.

10. (canceled)

11. The system of claim 1, wherein the generated product target is grammatically correct based on the attribute-value pairs of the product data associated with the product target.

12. The system of claim 1, wherein the semantic model is a scheme for classifying product data based on the attribute-value pairs of the product data and relationships between the attributes of the product data.

13. The system of claim 1, wherein the product advertising campaign is designed to associate at least one piece of product data to one or more keywords in a search query based on the at least one product target.

14. The system of claim 1, wherein the product advertisement generation application further configures the processor to generate a product feed based on the identified performance data.

15. A method for creating product advertising targets, comprising:
identifying at least one category in a portion of product data based upon the attribute-value pairs in the product data that associated with the category using a product advertisement generation server system;
determining a product advertising structure based on the product data and the identified at least one category using the product advertisement generation server system, where the product advertising structure includes one or more groupings of product data;
matching a portion of the groupings of product data with the product targets within the global performance data based on the attribute-value pairs of the product data associated within the portion of the groupings of product data using the product advertisement generation server system;
identifying performance data within the global performance data based on the matched product targets using the product advertisement generation server system, here the identified performance data corresponds to the attribute-value pairs in the matched portion of the groupings of product data; and
generating at least one product target based on the identified performance data, the semantic model, and the product data using the product advertisement generation server system, where a product target comprises a set of product attribute-value pairs identifying a portion of the product data; where the product target is augmented with at least one attribute-value pair described in the semantic model selected based on the identified performance data for at least one product target in the matched portion of the groupings of product data.

16. The method of claim 15, further comprising creating a product advertisement campaign comprising the at least one product target and portion of the product data using the product advertisement generation server system.

17. The method of claim 16, further comprising transmitting the product advertising campaign to a search engine provider using the product advertisement generation server system.

18. The method of claim 17, further comprising obtaining campaign performance data describing the performance of the product advertising campaign using the product advertisement generation server system.

19. The method of claim 18, further comprising:
determining the performance of a portion of the at least one product target in the product advertising campaign based on the campaign performance data using the product advertisement generation server system;
refining at least one of the portion of the at least one product target based on the determined performance using the product advertisement generation server system; and
updating the product advertising campaign to include the refined product target using the product advertisement generation server system.

20. The method of claim 18, further comprising:
generating at least one product bucket within the product advertising structure including at least one product target and product data associated with the at least one product target using the product advertisement generation server system, where a product bucket is a conceptual grouping of the at least one product target and product data based on one or more attributes;
determining performance information for the at least one product bucket based on the performance data using the product advertisement generation server system;
identifying the top product bucket within the at least one product bucket with the best performance using the product advertisement generation server system;
refining at least one of the at least one product target in the other at least one product bucket based on the top product targets contained in the top product bucket using the product advertisement generation server system; and
updating the product advertising campaign based on the refined product targets using the product advertisement generation server system.

21. The method of claim 15, further comprising generating at least one product group including at least one product target and product data associated with the at least one product target within the product advertising structure using the product advertisement generation server system.

22. The method of claim 21, further comprising:
obtaining search performance data from a search engine provider using the product advertisement generation server system, where the search performance data describes the performance of at least one attribute-value pair associated with a piece of product data; and
generating at least one performance product group within the product advertising structure based on the search performance data using the product advertisement generation server system, where a performance product group includes product data and associated product targets, where each piece of product data in the performance product group is associated with the same portion of the obtained search performance data.

23. The method of claim 15, further comprising:
determining a bidding strategy based on the product targets and the product data using the product advertisement generation server system, where the bidding strategy comprises one or more bid prices associated with a product target;
determining a bid price for the product advertising campaign based on the product advertising structure using the product advertisement generation server system; and
including the bid prices in the product advertising campaign using the product advertisement generation server system.
